(19) United States
(12) Patent Application Publication
(10) Pub. No.: US 2005/0041237 A1
(43) Pub. Date: Feb. 24, 2005

(54) Operating device

(76) Inventors: Andres Richter, Pforzheim (DE); Stefan Grohmann, Bretzfeld (DE); Jorg Lummerzheim, Lautertal (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 10/792,651

(22) Filed: Mar. 3, 2004

Related U.S. Application Data
(63) Continuation-in-part of application No. PCT/DE02/03287, filed on Sep. 6, 2002.

(30) Foreign Application Priority Data
Sep. 7, 2001 (DE) 201 14 869.2

(51) Int. Cl. G01B 11/14

(52) U.S. Cl. 356/71; 356/614

(57) ABSTRACT

In a device for operating a computer or computer-based apparatus comprising a first arrangement by which the position of an object on an axis can be determined, a second arrangement is provided by which, additionally the distance of the object from the axis can be determined.

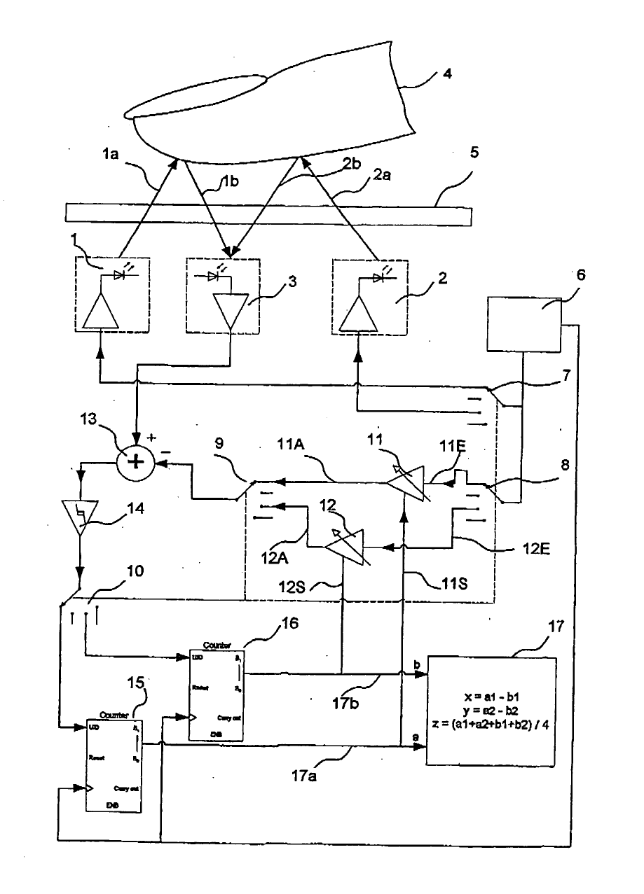

The invention resides in an apparatus for operating a computer-assisted device, comprising a first arrangement which is used to determine the position of an object on the axis.

Such an apparatus can be constructed for example with an arrangement known from EP 0 706 648 B1. The known arrangement is to be used preferably for the detection of water droplets on a glass panel since a windshield wiper can be activated depending on the droplets detected on the windshield.

In the known arrangement, two measuring paths are established between two radiation sources and a radiation receiver. The radiation emitted by the radiation source is reflected from the top side by water droplets present on the surface of the glass panel and are recorded by the radiation receiver. The two measuring paths are alternately operated by way of a tact generator in a time-dependent way.

The detection signals determined by the radiation receiver are filtered and are again divided in a synchronous modulator controlled by a tact generator into the detection signals assigned to the individual measurement paths. In a comparator, an application signal is determined therefrom, which can be utilized as basis for the wetting that has occurred. When the radiation signals emitted by the two radiation sources are reflected equally strongly, an application signal of zero is provided.

The application signal is supplied to a signal centering stage. Depending on whether there is a control voltage at the output of the signal centering stage, the radiation amount radiated into the measuring path is controlled by this control voltage, so that, depending on a time constant, a reverse control of the detector signal is obtained. In this way, it is made possible to determine dynamic changes in the sensor-active area of the measuring arrangement wherein at the same time a reliable external light compensation is said to occur.

By means of a suitable device, the radiation received by the radiation receivers which was reflected from an object disposed on a panel can also be utilized for determining the position of the object on the disc. In this way, the known arrangement can for example be used similar to the function of a so-called touchpad for controlling the cursor of a computer.

Functions other than the determination of the position for example of an XY-plane cannot be performed with the known arrangement or touch pad. If in a particular position another function is to be performed such as for example a zoom-function, a separate operating element must be actuated. This is very disadvantageous since upon activation of a separate operating element, the desired position in the XY-plane is often lost. Furthermore, the actuation of a separate operating element is also found annoying.

It is the object of the present invention to provide an arrangement as described above in such a way that it is suitable for performing another function in a simple manner.

The solution to this object is obtained by the features of the characterizing part of claim 1. Advantageous embodiments of the invention are defined in the sub-claims.

In accordance with the invention, a device for the operating of a computer or a computer-based apparatus includes a first arrangement by which the position of an object along an axis can be determined characterized in that means are provided by which the distance of the object from the axis can be determined.

Since means are provided by which the distance of the object from the axis can be determined, it is possible to perform a function which is dependent on the distance. While the first arrangement of elements is utilized for determining the position of an object on an axis or for example the XY plane, with the means the position of the object in Z-direction can be determined. The distance of the object from the axis or the XY plane which can be determined by the means can be used for controlling an independent function.

If the object is for example a human finger tip, for example, the first arrangement of elements can be used for controlling a cursor of a computer and the means for determining the distance from the XY plane can be used for controlling a zoom-function at the respective position in the XY plane as it is provided in a particular embodiment of the invention. Consequently, by means of the device according to the invention, a cursor of a computer can be controlled in a simple manner and at the same time a zoom function can be performed by movement of the finger in the Z-direction.

Although the use of the device according to the invention is particularly advantageous for controlling a cursor of a computer with an integrated zoom function, the device according to the invention can also be used for example in the area of TV and audio equipment. Furthermore, the device according to the invention can very well be utilized in the area of multi-media terminals in media applications in connection with presentation equipment. In addition, the device according to the invention can be used in connection with the remote control of games, particularly 3D games, especially in connection with joy sticks for game consoles. The device according to the invention is also very well usable in connection with cell phones, communicators, palm tops and similar equipment.

Very advantageous is an embodiment of the invention wherein the distance from the plane can be determined in a continuous way. This is particularly advantageous in connection with a zoom function.

An embodiment of the invention which includes at least two radiation emitters and a radiation receiver which receives radiation emitted from a respective emitter and reflected by the object whereby the differences of the reflected radiation received by the radiation receiver are evaluated, has been found to be very advantageous. The evaluation can occur for example by forming the ratio of the reflection radiation received from the respective radiation receiver. That is for example for determining the distance of the object from the axis or, respectively the plane, the ratio of the reflected radiation of the radiation emitter received by the radiation receiver is formed. For determining the distance of the object from the axis or respectively the plane, the sum of the reflected radiation of some or all radiation emitters received by the radiation receiver can be formed.

An embodiment of the invention wherein for the determination of the position of the object on the axis or, respectively the plane, the difference of the reflected radiation of the radiation emitters received by the radiation receivers is formed and for the determination of the distance of the object from the axis or respectively from the plane the sum of the reflected radiation received by the radiation receiver is formed has been found to be very advantageous.

Because the position of the object on the axis or respectively the plane if applicable, is formed by the difference of the radiation received by the radiation receiver and, for determining the distance of the object from the axis or, respectively the plane, the sum of radiation received by the radiation receiver is formed, with few circuit components, a very reliably operating circuit can be provided. This is, because for forming the difference and for forming the sum, largely the same components can be used.

In another particularly advantageous embodiment of the invention, the radiation emitters emit radiation impulses and the respective impulses received by the radiation receiver are compensated for by respective associated internal pulses. By compensating for the impulses, a very reliable operation of the circuit can be achieved. Furthermore, by means of the compensation impulses, the difference and respectively the sum of the radiation received by the radiation receiver can be formed in a simple manner.

For the compensation controllable amplifiers can be used whose control signals are employed to determine the position of the object on the axis or, respectively the plane by forming the difference, and for determining the distance of the object from the axis or respectively, from the plane, the sum is formed as it is provided in another particular embodiment of the invention. In this case, the means is in the form of a computer element by which the difference or respectively the sum is formed.

Further particulars, features and advantages of the present invention are apparent from the following description of a particular embodiment with reference to the drawing.

The sole figure shows a schematic arrangement of a device according to the invention.

As apparent from the figure, from a first radiation emitter 1, which includes an LED controlled by a driver, an infrared beam 1a is sent out. The infrared beam 1a passes through an axis 5 consisting of glass and is reflected by a finger tip 4 of a human. The reflected beam 1b also passes through the axis of glass 5 and is received by the radiation receiver 3, which includes a photo diode and an amplifier.

In the same way as the light beam 1a emitted by the first radiation emitter 1 is reflected from the finger tip 4 and received by the radiation receiver 3, a light beam 2a which is emitted by a second radiation receiver 2 and which has the same design as the first radiation emitter 1 is reflected from the finger tip 4 and received by the radiation receiver 3.

The first radiation emitter 1 and the second radiation emitter 2 are controlled by a pulse generator 6 in a time-shifted manner. In accordance therewith, the radiation receiver 3 receives the reflected light beam 1b of the radiation emitter 1 time-shifted with respect to the reflected light beam 2b of the radiation emitter 2. The reflected light beam 1b, 2b of the radiation emitters 1, 2 received by the radiation receiver 3 are supplied to a summing device 13.

Furthermore, additional signals of reversed polarity are supplied to the summing device 13 so as to be compensated by the signals provided by the radiation receiver 3. The compensation signals are the output signals of controllable amplifiers 11, 12 to the inputs 11, 12E of which also the signals provided by the pulse generator 6 are applied. The second controllable amplifier 12 is at the same time controlled by the second radiation emitter 2.

The signal emitted by the summing device 13 is applied to the input of a comparator 14. The output signal of the comparator 14 is supplied during the time, in which the first radiation emitter 1 is addressed, to the counting direction input of a first counter 15 to the counting input of which the output signal of the pulse generator 6 is applied. The output signal of the comparator 14 is supplied during the time in which the second radiation emitter 2 is addressed, to the counting direction input of a second counter 16 to the counting input of which the output signal of the pulse generator 6 is applied. The output signal of the first counter 15 is supplied to the control input 11s of the first controllable amplifier 11. The output signal of the second counter 16 is supplied to the control input 12s of the second controllable amplifier 12. Furthermore, the output signal of the first counter 15 is applied to the first input 17a of a computer element 17 and the output signal of the second counter 16 is supplied to the second input 17b of the computer element 17.

The signals are time-coordinated by means of switches 7, 8, 9, and 10 which switch synchronously.

If the comparison in the summing device 13 indicates that the signal of the radiation emitter 1 received by the radiation receiver 3 is greater than the output signal of the first controllable amplifier 11 applied at the same time to the summing device 13, the output signal of the comparator 14 causes the first counter 15 to count upwardly. As a result, the output signal of the first counter 15 is increased so that the amplification of the first controllable amplifier increases. This procedure is repeated until the signal provided by the first controllable amplifier 11 is greater than the respective output signal of the radiation receiver 3.

If the output signal of the radiation receiver 3 is smaller than the respective output signal of the first controllable amplifier 11, the output signal of the comparator 14 causes the counter 15 to count downwardly. Then the signal applied to the control input 11S of the first controllable amplifier 11, whereby the amplification of the first amplifier 11 is reduced with the result that the output signal of the first controllable amplifier 11 is reduced. Consequently, the output signal of the first counter 15 changes around a certain value.

In the way described hereabove also the second counter 16 is operated, which processes the signal supplied by the second radiation emitter 2, in connection with the second controllable amplifier 12.

Since the intensity of signals of the radiation emitters 1, 2 reflected by the finger tip 4 depends on the position of the finger tip 4, these signals can be used to determine the position of the finger tip 4 relative to the radiation emitter 1, 2. The position is determined in that in the computer element 17, the difference between the output signals of the first counter 15 and the output signals of the second counter 16 is formed. The difference value is a measure for the position of the finger tip 4 on the axis 5.

Since the strength of the radiation reflected back from the finger tip 4 depends also on the distance of the finger tip 4 from the radiation receiver 3 or, respectively, the axis 5, the radiation received by the radiation receiver 3 may also be used for determining the distance of the finger tip from the radiation receiver 3 or respectively the axis 5. To this end in the computer element 17, the output signals of the counter 15 and 16 are added up. The summation signal represents a measure for the distance of the finger tip 4 from the axis 5.

If the axis 5 shown in the figure represents the X-axis of an XY-plane, and if the same setup is used for the representation of the Y-axis, the position of the finger tip 4 on the plane defined by the X-axis and the Y-axis can be determined. For determining the distance of the finger tip 4 from the plane then, however, the sum of the impulses emitted by all four radiation emitters and reflected impulses is formed.

1. Device for operating a computer or a computer-based apparatus, comprising a first arrangement (1, 2, 3) by which the position of an object (4) on an axis (5) can be determined, characterized in that,
means (17) are provided by which the distance of the object (4) from the axis (5) can be determined.

2. Device according to claim 1, characterized in that,
a second arrangement is present by which the position of the object (4) on a plane can be determined wherein by the means (17) the distance of the object (4) from the plane can be determined.

3. Device according to claim 1 or 2, characterized in that,
the first arrangement (1, 2, 3) and if applicable, the second arrangement are used for controlling the position of a cursor on an imaging element and the means (17) is used for controlling a zoom function.

4. Device according to claim 2 or 3, characterized in that,
the second arrangement is essentially identical to the first arrangement (1, 2, 3).

5. Device according to one of claims 1 to 4, characterized in that,
the distance of the object (4) from the axis (5), or respectively if applicable from the plane, can be determined in a continuous way.

6. Device according to one of the claims 1 to 5, characterized in that,
at least two radiation emitters (1, 2) are provided and one radiation receiver (3) is provided which receives radiation (1a, 2a) emitted by a respective radiation emitter (1, 2) and reflected (1b, 2b) by the object (4), wherein for determining the position of the object (4) on the axis (5), or respectively, if applicable on the plane, the differences of the reflected radiation (1b, 2b) received by the radiation receiver are evaluated.

7. Device according to claim 6, Characterized in that,
for determining the position of the object (4) on the axis (5) or respectively, if applicable, on the plane, the difference of the reflected radiation (1b, 2b) of the radiation emitters (1, 2) received by the radiation receiver (3) is formed and for determining the distance of the object (4) from the axis (5) or respectively if applicable, from the plane, the sum of the reflected radiation (1b, 2b) of the radiation emitter (1, 2) received by the radiation receiver is formed.

8. Device according to claim 6 or 7, characterized in that
the radiation emitter (1, 2) emits radiation impulses and the respective impulses received by the radiation receiver (3) are compensated for by a respective associated internal impulse.

9. Device according to claim 8, characterized in that
for the compensation controllable amplifiers (11, 12) are used and the means (17) are in the form of a computer element (17) which forms the difference of the control signals (11s, 12s) of the amplifiers (11, 12) for determining the position of the object (4) on the axis (5) or respectively if applicable, on the plane, and which, for determining the distance of the object (4) from the axis 5 or respectively if applicable from the plane, forms the sum of the control signals.
